(19) United States
(12) Patent Application Publication
(10) Pub. No.: US 2026/0216997 A1
(43) Pub. Date: Jul. 30, 2026

(54) BREATHABLE ARTICLES

(71) Applicant: Dow Global Technologies LLC, Midland, MI (US)

(72) Inventors: Albert Carbonell Blanch, Tarragona (ES); Georgia Natacha Eftalie Bitinis, Tarragona (ES); Rajen M. Patel, Missouri City, TX (US)

(21) Appl. No.: 19/041,264

(22) Filed: Jan. 30, 2025

(51) Int. Cl. B32B 9/04; B32B 27/32

(52) U.S. Cl. CPC B32B 9/045; B32B 27/32; B32B 2250/05; B32B 2305/026; B32B 2307/30; B32B 2307/72; B32B 2307/724; B32B 2311/00; B32B 2323/046; B32B 2323/10

(57) ABSTRACT

Embodiments of the present disclosure are directed towards breathable articles including a porous layer including calcium carbonate and a breathable layer material, wherein the breathable layer material has a density greater than 0.915 g/cm³ and melt index (I₂) from 0.5 to 5 dg/min; and a non-porous layer including a non-porous layer material, wherein the non-porous layer material has a density less than 0.910 g/cm³ and melt index (I₂) from 0.5 to 5 dg/min.

### FIELD OF DISCLOSURE

Embodiments of the present disclosure are directed towards breathable articles including a porous layer and a non-porous layer.

### BACKGROUND

Breathable films can be made by dispersing inorganic particles into a polymer followed by forming a film of the filled polymer and stretching the film to provide porosity. A number of properties can be considered for breathable films, such as breathability, softness, comfort, toughness or/and barrier properties. There remains a need for articles that can provide one or more advantageous properties.

### SUMMARY

The present disclosure provides various embodiments, including, without limitation, the following.

A breathable article including a porous layer including calcium carbonate and a breathable layer material, wherein the breathable layer material has a density greater than 0.915 g/cm³ and melt index (I₂) from 0.5 to 5 dg/min; and a non-porous layer including a non-porous layer material, wherein the non-porous layer material has a density less than 0.910 g/cm³ and melt index (I₂) from 0.5 to 5 dg/min.

### DETAILED DESCRIPTION

The present disclosure is directed toward breathable articles. The breathable articles disclosed herein include a number of layers that include calcium carbonate (CaCO₃) and a breathable layer material and a number of layers that include a non-porous layer material. Advantageously, these breathable articles have one or more desirable properties, as compared to a number of other articles, as discussed further herein.

As used herein “breathable article” refers to an article having a water vapor transmission rate (WVTR) greater than or equal to 400 g/m² day. Breathable articles are desirable for a number of applications, such as hygiene applications and/or medical applications, for instance. Herein, non-breathable articles, e.g., having a WVTR less than 400 g/m² day, are not suitable for a number of applications, in contrast to the breathable articles disclosed herein.

As used herein, “layer” refers to a continuous or substantially continuous sheet or stratum of material that forms part of a multilayer article, e.g., the breathable articles disclosed herein. A layer may be comprised of a single material or a blend of materials and may possess distinct physical or chemical properties relative to adjacent layers. The layers can be laminated, co-extruded, or otherwise combined to form the breathable articles disclosed herein. Multilayer films are known and known components, e.g., known processes and conditions, may be utilized to make the breathable articles disclosed herein.

The breathable articles disclosed herein include a number of layers that include CaCO₃ and a breathable layer material, e.g. polyethylene. Layers that include CaCO₃ and a breathable layer material can be referred to as “porous layers”. CaCO₃ can be utilized to facilitate generation of pores upon stretching, e.g., by using a machine direction orientation process and/or a ring-rolling process. Without wishing to be being bound to theory, it is believed that these pores can help provide breathability for the breathable articles disclosed herein.

Calcium carbonate, which can be referred to as a pore-forming filler, is a known component that has been utilized in films. The CaCO₃ can be in the form of particles. Different particles can be used for various applications. The CaCO₃ can be obtained commercially. Examples of commercially available CaCO₃ include those under the tradename OMYAFILM available from Omya and those under the tradename FILMLINK available from Imeyrs.

As mentioned, the breathable articles disclosed herein include a number of layers, i.e. porous layers, that include CaCO₃ and a breathable layer material. Embodiments provide that the breathable layer material is a polymer, such as polyethylene or polypropylene.

The term “polymer” refers to a polymeric compound prepared by polymerizing monomers, whether of a same or a different type. The generic term polymer thus embraces the term “homopolymer,” which usually refers to a polymer prepared from only one type of monomer as well as “copolymer,” which refers to a polymer prepared from two or more different monomers.

Ethylene-based polymers, refers to polymers comprising greater than 50% by mole of units derived from ethylene monomer. This includes ethylene-based homopolymers or copolymers, indicating that units are derived from two or more comonomers. Ethylene-based polymers comprising greater than 50% by mole of units derived from ethylene monomer are known in the art.

Propylene-based polymers, refers to polymers comprising greater than 50% by mole of units derived from propylene monomer. This includes propylene-based homopolymers or copolymers, indicating that units are derived from two or more comonomers. Propylene-based polymers comprising greater than 50% by mole of units derived from propylene monomer are known in the art.

One or more embodiments provide that from 55 to 100 wt % of the breathable layer material is derived from ethylene monomers, based on a total weight of the breathable layer material. All individual values and subranges from 55 to 100 wt % are included; for example, the breathable layer material can have from a lower limit of 55, 60, 70, 75, or 80 wt % of units derived ethylene monomers to an upper limit of 100, 98, 95, 90, or 85 wt % of units derived ethylene monomers based upon the total weight of the breathable layer material.

One or more embodiments provide that from 2 to 45 wt % of breathable layer material is derived from alpha olefin comonomers, when a comonomer is utilized, based on a total weight of the breathable layer material. All individual values and subranges from 2 to 45 wt % are included; for example, the breathable layer material can have from a lower limit of 2, 5, 10, or 15 wt % of units derived alpha olefin comonomers to an upper limit of 45, 40, 30, 25, or 20 wt % of units derived alpha olefin based upon the total weight of the breathable layer material.

Embodiments provided that the breathable layer material has a density greater than 0.915 g/cm³. For instance, the breathable layer material can have a density from 0.916 g/cm³ to 0.940 g/cm³. All individual values and subranges from 0.916 g/cm³ to 0.940 g/cm³ are included; for example, the breathable layer material can have a density from a lower limit of 0.916, 0.916, 0.918, or 0.920 g/cm³ to an upper limit of 0.940, 0.938, or 0.935 g/cm³. Density can be determined according to ASTM D 792.

Embodiments provided that the breathable layer material has a melt index (12) from 0.5 to 5 dg/min. All individual values and subranges from 0.5 to 5 dg/min are included; for example, the breathable layer material can have an I₂ from a lower limit of 0.5, 0.75 or 1 dg/min to an upper limit of 5, 4, 3, or 2 dg/min. I₂ can be determined according to ASTM D1238, measured at 190° C. and with a 2.16 kg weight.

One or more embodiments provide that a blend of breathable layer materials is utilized. “Blend” and “blend of breathable layer materials,” refer to a composition of two or more polymers. Such a blend may or may not be miscible. Such a blend may or may not be phase separated. Such a blend may or may not contain one or more domain configurations, as determined from transmission electron spectroscopy, light scattering, x-ray scattering, and/or any other method known in the art. “Blend” and “blend of breathable layer materials,” do not refer to laminates, but one or more layers, as discussed herein, may contain a blend. Such blends can be prepared as dry blends, formed in situ, e.g., in a reactor, melt blends, or using other techniques known to those of skill in the art. Various breathable layer materials and/or blends of breathable layer materials can be used for different applications.

Embodiments of the present disclosure provide that the breathable layer material can be made by a number of processes, e.g. with conventional reaction components, reaction conditions, reaction times, and isolation procedures, utilized for making known ethylene-based polymers. Embodiments of the present disclosure provide that the breathable layer material can be obtained commercially. Examples of commercially available breathable layer materials are ethylene-based polymers available under the tradenames DOWLEX, such as DOWLEX 2045G and DOWLEX 2042C, ELITE, and DOWLEX GM available from the Dow Chemical Company, among other breathable layer materials. One or more embodiments of the present disclosure provide that the breathable layer material is polyethylene. One or more embodiments of the present disclosure provide that the breathable layer material is linear low-density polyethylene (LLDPE).

Embodiments provide that for respective layers that include CaCO₃ and a breathable layer material, the CaCO₃ is from 40 to 60 wt % based upon a total weight of the CaCO₃ and the breathable layer material in that layer. All individual values and subranges from 40 to 60 wt % are included; for example, the CaCO₃ can be from a lower limit of 40, 43, or 47 wt % to an upper limit of 60, 57, or 53 wt % based upon the total weight of the CaCO₃ and the breathable layer material in that layer.

The breathable articles disclosed herein include a number of layers that include a non-porous layer material. Layers that include a non-porous layer material while also not including, in other words are essentially free of, pore-forming filler, e.g., inorganic filler CaCO₃, can be referred to as “non-porous layers”. As used herein, a non-porous layer being essentially free of pore-forming filler includes less than 1 wt % pore-forming filler based upon a total weight of the non-porous layer.

Embodiments provide that the non-porous layer material is a polymer. One or more embodiments provide that the non-porous layer material is an ethylene-based polymer. One or more embodiments provide that the non-porous layer material is a propylene-based polymer.

One or more embodiments provide that from 55 to 90 wt % of the non-porous layer material is derived from ethylene monomers, based on a total weight of the non-porous layer material. All individual values and subranges from 55 to 90 wt % are included; for example, the non-porous layer material can have from a lower limit of 55, 60, 70, or 75 wt % of units derived ethylene monomers to an upper limit of 90, 85, or 80 wt % of units derived ethylene monomers based upon the total weight of the non-porous layer material.

One or more embodiments provide that from 55 to 96 wt % of the non-porous layer material is derived from propylene monomers, based on a total weight of the non-porous layer material. All individual values and subranges from 55 to 96 wt % are included; for example, the non-porous layer material can have from a lower limit of 55, 60, 70, or 75 wt % of units derived propylene monomers to an upper limit of 96, 90, 85, or 80 wt % of units derived propylene monomers based upon the total weight of the non-porous layer material.

One or more embodiments provide that from 4 to 45 wt % of non-porous layer material is derived from olefin comonomers, e.g., terminal alkene comonomers and/or diene comonomers, based on a total weight of the non-porous layer material. All individual values and subranges from 4 to 45 wt % are included; for example, the non-porous layer material can have from a lower limit of 4, 10, 15, or 20 wt % of units derived olefin comonomers to an upper limit of 45, 40, 30, or 25 wt % of units derived from olefin comonomers based upon the total weight of the non-porous layer material.

Embodiments provided that the non-porous layer material has a density less than 0.910 g/cm³. For instance, the non-porous layer material can have a density from 0.850 g/cm³ to 0.909 g/cm³. All individual values and subranges from 0.850 g/cm³ to 0.909 g/cm³ are included; for example, the non-porous layer material can have a density from a lower limit of 0.850, 0.855, 0.860 or 0.865 g/cm³ to an upper limit of 0.909, 0.908, 0.907 or 0.906 g/cm³. Density can be determined according to ASTM D 792.

Embodiments provided that the non-porous layer material has a melt index (I₂) from 0.5 to 5 dg/min. All individual values and subranges from 0.5 to 5 dg/min are included; for example, the non-porous layer material can have an 12 from a lower limit of 0.5 or 0.75 dg/min to an upper limit of 5, 4, 3, or 2 dg/min. I₂ can be determined according to ASTM D1238, measured at 190° C. and with a 2.16 kg weight.

One or more embodiments provide that a blend of non-porous layer materials is utilized. Embodiments provide that that each non-porous layer material in the blend respectively has a density from 0.850 g/cm³ to 0.909 g/cm³ and a melt index (I₂) from 0.3 to 5 dg/min. Such a blend may or may not be miscible. Such a blend may or may not be phase separated. Such a blend may or may not contain one or more domain configurations, as determined from transmission electron spectroscopy, light scattering, x-ray scattering, and/or any other method known in the art. “Blend” and “blend of breathable layer materials,” do not refer to laminates, but one or more layers, as discussed herein, may contain a blend. Such blends can be prepared as dry blends, formed in situ, e.g., in a reactor, melt blends, or using other techniques known to those of skill in the art. Various non-porous layer materials and/or blends of non-porous layer materials can be used for different applications.

Embodiments of the present disclosure provide that the non-porous layer material can be made by a number of processes, e.g. with conventional reaction components, reaction conditions, reaction times, and isolation procedures, utilized for making known ethylene-based polymers. Embodiments of the present disclosure provide that the non-porous layer material can be obtained commercially. Examples of commercially available non-porous layer materials are ethylene-based polymers and propylene-based polymers available under the tradenames INFUSE, ENGAGE, VERSIFY, AFFINITY, and ATTANE, available from the Dow Chemical Company, among other breathable layer materials. Specific examples include INFUSE 9107, ENGAGE 8100, VERSIFY 2300, AFFINITY 1880G, and ATTANE SL4102G. One or more embodiments provide that the non-porous layer material is a Polyolefin Elastomer (POE). One or more embodiments provide that the non-porous layer material is a Polyolefin Plastomer (POP).

As mentioned, the breathable articles disclosed herein include a number of layers that include calcium carbonate (CaCO₃) and a breathable layer material, which can be referred to as “porous layers” and a number of layers that include a non-porous layer material, which can be referred to as “non-porous layers”.

Embodiments provide that the breathable articles can include different numbers of layers for various applications. For instance, embodiments provide that the breathable articles disclosed herein can include from 3 to 11 layers. Embodiments provide that the 3 to 11 layers is a sum of the number of porous layers and the number of non-porous layers. One or more embodiments provide that the breathable article includes only 3 layers. One or more embodiments provide that the multilayer article includes only 5 layers. One or more embodiments provide that the multilayer article includes only 7 layers. One or more embodiments provide that the multilayer article includes only 9 layers. One or more embodiments provide that the multilayer article includes only 11 layers.

Embodiments provide that the layers of breathable articles can have different arrangements for various applications. A number of embodiments provide that breathable articles are symmetric about a central layer. The central layer may be a porous layer or a non-porous layer. For instance, designating porous layers as “A” layers and non-porous layers as “B” layers, the of breathable articles can have different arrangements such as: A/B/A/B/A, B/A/B/A/B/A/B, A/B/A/B/A/B/A, B/A/B/A/B, or A/B/A. A number of embodiments provide that the A layers of the breathable article alternate with the B layers of the breathable article; however, embodiments are not so limited. A number of embodiments provide that the breathable articles include a plurality of A layers. One or more embodiment provide that each A layer has a first same composition and that each B layer has a second same composition, where the first same composition is different than the second same composition.

The breathable articles disclosed herein can be made using known processes, equipment, conditions, and components, and such. One or more embodiments provide that the breathable articles disclosed herein can be made a blown film process. One or more embodiments provide that the breathable articles disclosed herein can be made a cast film process.

Embodiments of the present disclosure provide that the breathable articles are stretched. Known stretching processes may be utilized. As mentioned, CaCO₃ can be utilized to facilitate generation of pores upon stretching. One or more embodiments provide that the breathable articles disclosed herein can be stretched by a machine direction orientation process. One or more embodiments provide that the breathable articles disclosed herein can be stretched by a ring-rolling process.

One or more embodiments provide that the breathable articles disclosed herein can be stretched uniaxially. The uniaxial stretching can be in the machine direction. A stretch ratio, which may also be referred to as a draw ratio, during stretching can be from 2 to 6, e.g., the linear speed of the film exiting the stretching operation is 2 to 6 times the speed of the precursor film entering the stretching operation. All individual values and subranges from 2 to 6 are included; for example, the stretch ratio can be from a lower limit of 2, 3, or 3.5 to an upper limit of 6 or 5.

The breathable articles disclosed herein can have a basis weight from 5 to 30 grams/m². All individual values and subranges from 5 to 30 grams/m² are included; for example, the breathable articles can have a basis weight from a lower limit of 5, 8 or 10 grams/m² to an upper limit of 30, 25, or 15 grams/m². Basis weight can be determined as a product of the density of breathable article and the total thickness of the breathable article.

The breathable articles disclosed herein can have a total thickness, e.g., a post stretching thickness, from 5 to 100 micrometers (μm). All individual values and subranges from 5 μm to 100 μm are included; for example, the breathable articles can have total thickness from a lower limit of 5, 10, 20 or 25 μm to an upper limit of 100, 75, 50 or 30 μm. As used herein, a “total thickness”, refers to a distance that includes each of the number of porous layers and each of the number of non-porous layers.

Embodiments of the present disclosure provide that the number of non-porous layers, e.g., a sum of the number of non-porous layers, of the breathable article is equal to or less than 15% of the total thickness, e.g., a post stretching thickness, of the breathable articles disclosed herein. For instance, the breathable articles can include the number of non-porous layers from 5% to 15% based on the total thickness (100%) of the breathable article. All individual values and subranges from 5% to 15% are included; for example, the number of non-porous layers can be from a lower limit of 5, 6, or 7% to an upper limit of 15, 13, or 11% based on the total thickness of the breathable article. Embodiments of the present disclosure provide a thickness percent of the number of non-porous layers and a thickness percent of the number of porous layers of the breathable article sum to the total thickness percent of 100%.

Embodiments of the present disclosure provide that each respective layer of the number of non-porous layers of the breathable article are from 2% to 15% based on the total thickness (100%) of the breathable article. All individual values and subranges from 2% to 15% are included; for example, each respective layer of the number of non-porous layers can be from a lower limit of 2, 3, or 4% to an upper limit of 15, 13, or 10% based on the total thickness of the breathable article. One or more embodiments of the present disclosure provide that each respective layer of the number of non-porous layers of the breathable article has a same % thickness based on the total thickness of the breathable article. One or more embodiments of the present disclosure provide that each respective layer of the number of non-porous layers of the breathable article has a different % thickness based on the total thickness of the breathable article. One or more embodiments of the present disclosure provide that two or more respective layers of the number of non-porous layers of the breathable article have a first % thickness, while one or more respective layers of the number of non-porous layers have a second % thickness where the first % thickness is different than the second % thickness.

Embodiments of the present disclosure provide that each respective layer of the number of porous layers of the breathable article are from 5% to 75% based on the total thickness (100%) of the breathable article. All individual values and subranges from 5% to 75% are included; for example, each respective layer of the number of porous layers can be from a lower limit of 5, 8, or 10% to an upper limit of 75, 70, or 68% based on the total thickness of the breathable article. One or more embodiments of the present disclosure provide that each respective layer of the number of porous layers of the breathable article has a same % thickness based on the total thickness of the breathable article. One or more embodiments of the present disclosure provide that each respective layer of the number of porous layers of the breathable article has a different % thickness based on the total thickness of the breathable article. One or more embodiments of the present disclosure provide that two or more respective layers of the number of porous layers of the breathable article have a first % thickness, while one or more respective layers of the number of porous layers have a second % thickness where the first % thickness is different than the second % thickness.

As mentioned, the breathable articles disclosed herein have a water vapor transmission rate (WVTR) greater than or equal to 400 g/m² day. For instance, the breathable articles can have a WVTR from 400 to 2,000 g/m² day. All individual values and subranges from 400 to 2,000 g/m² day are included; for example, breathable articles can have a WVTR from a lower limit of 400, 425, or 450 g/m² to an upper limit of 2,000, 1,750, or 1,500 g/m². WVTR can be determined according to ASTM E398-03, with a temperature of 37.8° C. and 90% relative humidity. Breathability is desirable for a number of applications.

One or more embodiments provide that the breathable articles disclosed herein can provide a maintained or an improved, i.e., greater, CD Tensile Force at break, as compared to other articles having a similar porous layer composition. A maintained or an improved CD Tensile Force at break is desirable for a number of applications. For instance, a maintained or an improved CD Tensile Force at break can help provide for Tear Resistance values. Additionally, a maintained or an improved CD Tensile Force at break can help provide that the breathable articles maintain their structure better during processing and handling, e.g., as compared to articles with a lower CD Tensile Force at break. CD Tensile Force at break can be determined in accordance with ISO 527.

One or more embodiments provide that the breathable articles disclosed herein can provide an improved i.e., greater, MD Tear, as compared to other articles having a similar porous layer. An improved MD Tear is desirable for a number of applications. For instance, an improved MD Tear can help provide a greater resistance to tearing when subjected to forces during processing, application, or use. MD Tear can be determined in accordance with ASTM D1922-09.

Advantageously, the breathable articles disclosed herein can provide improved, i.e., greater, odor barrier properties, as compared to other articles having a similar porous layer. An improved odor barrier is desirable for a number of applications.

Advantageously, the breathable articles disclosed herein can be utilized for a number of applications, such as hygiene articles or medical articles, among other others.

### EXAMPLES

In the Examples, various terms and designations for materials are used including, for instance, the following:
Calcium carbonate (OmyaFilm 758-AV obtained from Omya).
Breathable layer material-1 (LLDPE; density 0.920 g/cm³; melt index I₂ 1.0 dg/min; DOWLEX 2045G obtained from the Dow Chemical Company).
Breathable layer material-2 (LLDPE; density 0.930 g/cm³; melt index I₂ 1.0 dg/min; DOWLEX 2042EC obtained from the Dow Chemical Company).
Non-porous layer material-1 (density 0.866 g/cm³; melt index I₂ 1.0 dg/min; INFUSE 9107 obtained from the Dow Chemical Company).
Non-porous layer material-2 (density 0.870 g/cm³; melt index I₂ 1.0 dg/min; ENGAGE 8100 obtained from the Dow Chemical Company).
Non-porous layer material-3 (density 0.867 g/cm³; melt index I₂ 2.0 dg/min; VERSIFY 2300 obtained from the Dow Chemical Company).
Non-porous layer material-4 (density 0.902 g/cm³; melt index I₂ 1.0 dg/min; AFFINITY 1880G obtained from the Dow Chemical Company).
Non-porous layer material-5 (density 0.905 g/cm³; melt index I₂ 1.0 dg/min; ATTANE SL 4102G obtained from the Dow Chemical Company).

Examples 1-7, breathable articles, are reported in Tables 1-7. Comparative Examples A-C are reported in Tables 8-10.

TABLE 1

| | Example 1 | | | | |
|---|---|---|---|---|---|
| | Grams per square meter | | | | |
| | 15 | | | | |
| | Stretch ratio | | | | |
| | 4 | | | | |
| | Layer | Layer | Layer | Layer | Layer |
| | 1 | 2 | 3 | 4 | 5 |
| CaCO₃ | 49 wt % | — | 49 wt % | — | 49 wt % |
| Breathable | 21 wt % | — | 21 wt % | — | 21 wt % |
| layer | | | | | |
| material-1 | | | | | |
| Breathable | 30 wt % | — | 30 wt % | — | 30 wt % |
| layer | | | | | |
| material-2 | | | | | |
| Non- | — | 100 wt % | — | 100 wt % | — |
| porous | | | | | |
| layer | | | | | |
| material-4 | | | | | |
| Percentage | 10 | 7 | 66 | 7 | 10 |
| of Total | | | | | |
| Thickness | | | | | |
| (%) | | | | | |

TABLE 2

| | Example 2 | | | | |
|---|---|---|---|---|---|
| | Grams per square meter | | | | |
| | 15 | | | | |
| | Stretch ratio | | | | |
| | 4 | | | | |
| | Layer | Layer | Layer | Layer | Layer |
| | 1 | 2 | 3 | 4 | 5 |
| CaCO₃ | 49 wt % | — | 49 wt % | — | 49 wt % |
| Breathable | 21 wt % | — | 21 wt % | — | 21 wt % |
| layer | | | | | |
| material-1 | | | | | |
| Breathable | 30 wt % | — | 30 wt % | — | 30 wt % |
| layer | | | | | |
| material-2 | | | | | |
| Non- | — | 100 wt % | — | 100 wt % | — |
| porous | | | | | |
| layer | | | | | |
| material-1 | | | | | |
| Percentage | 10 | 7 | 66 | 7 | 10 |
| of Total | | | | | |
| Thickness | | | | | |
| (%) | | | | | |

TABLE 3

| | Example 3 | | | | |
|---|---|---|---|---|---|
| | Grams per square meter | | | | |
| | 15 | | | | |
| | Stretch ratio | | | | |
| | 4 | | | | |
| | Layer | Layer | Layer | Layer | Layer |
| | 1 | 2 | 3 | 4 | 5 |
| CaCO₃ | 49 wt % | — | 49 wt % | — | 49 wt % |
| Breathable | 21 wt % | — | 21 wt % | — | 21 wt % |
| layer | | | | | |
| material-1 | | | | | |
| Breathable | 30 wt % | — | 30 wt % | — | 30 wt % |
| layer | | | | | |
| material-2 | | | | | |
| Non- | — | 100 wt % | — | 100 wt % | — |
| porous | | | | | |
| layer | | | | | |
| material-3 | | | | | |
| Percentage | 10 | 7 | 66 | 7 | 10 |
| of Total | | | | | |
| Thickness | | | | | |
| (%) | | | | | |

TABLE 4

| | Example 4 | | | | |
|---|---|---|---|---|---|
| | Grams per square meter | | | | |
| | 15 | | | | |
| | Stretch ratio | | | | |
| | 4 | | | | |
| | Layer | Layer | Layer | Layer | Layer |
| | 1 | 2 | 3 | 4 | 5 |
| CaCO₃ | 49 wt % | — | 49 wt % | — | 49 wt % |
| Breathable | 21 wt % | — | 21 wt % | — | 21 wt % |
| layer | | | | | |
| material-1 | | | | | |
| Breathable | 30 wt % | — | 30 wt % | — | 30 wt % |
| layer | | | | | |
| material-2 | | | | | |
| Non- | — | 100 wt % | — | 100 wt % | — |
| porous | | | | | |
| layer | | | | | |
| material-2 | | | | | |
| Percentage | 10 | 7 | 66 | 7 | 10 |
| of Total | | | | | |
| Thickness | | | | | |
| (%) | | | | | |

TABLE 5

| | Example 5 | | | | |
|---|---|---|---|---|---|
| | Grams per square meter | | | | |
| | 15 | | | | |
| | Stretch ratio | | | | |
| | 4 | | | | |
| | Layer | Layer | Layer | Layer | Layer |
| | 1 | 2 | 3 | 4 | 5 |
| CaCO₃ | 49 wt % | — | 49 wt % | — | 49 wt % |
| Breathable | 21 wt % | — | 21 wt % | — | 21 wt % |
| layer | | | | | |
| material-1 | | | | | |
| Breathable | 30 wt % | — | 30 wt % | — | 30 wt % |
| layer | | | | | |
| material-2 | | | | | |
| Non- | — | 100 wt % | — | 100 wt % | — |
| porous | | | | | |
| layer | | | | | |
| material-5 | | | | | |
| Percentage | 15 | 5 | 60 | 5 | 15 |
| of Total | | | | | |
| Thickness | | | | | |
| (%) | | | | | |

TABLE 6

| | Example 6 | | |
|---|---|---|---|
| | Grams per square meter | | |
| | 15 | | |
| | Stretch ratio | | |
| | 4 | | |
| | Layer 1 | Layer 2 | Layer 3 |
| CaCO₃ | 49 wt % | — | 49 wt % |
| Breathable | 21 wt % | — | 21 wt % |
| layer | | | |
| material-1 | | | |
| Breathable | 30 wt % | — | 30 wt % |
| layer | | | |
| material-2 | | | |
| Non- | — | 100 wt % | — |
| porous | | | |
| layer | | | |
| material-5 | | | |
| Percentage | 45 | 10 | 45 |
| of Total | | | |
| Thickness | | | |
| (%) | | | |

TABLE 7

| | Comparative Example A |
|---|---|
| | Grams per square meter |
| | 15 |
| | Stretch ratio |
| | 4 |
| | Layer 1 |
| CaCO₃ | 49 wt % |
| Breathable | 21 wt % |
| layer | |
| material-1 | |
| Breathable | 30 wt % |
| layer | |
| material-2 | |
| Percentage | 100 |
| of Total | |
| Thickness | |
| (%) | |

TABLE 8

| | Comparative Example B |
|---|---|
| | Grams per square meter |
| | 15 |
| | Stretch ratio |
| | 4 |
| | Layer 1 |
| CaCO₃ | 49 wt % |
| Breathable | 21 wt % |
| layer | |
| material-1 | |
| Breathable | 20 wt % |
| layer | |
| material-2 | |
| Non- | 10 wt % |
| porous | |
| layer | |
| material-5 | |
| Percentage | 100 |
| of Total | |
| Thickness | |
| (%) | |

TABLE 9

| | Comparative Example C | | | | |
|---|---|---|---|---|---|
| | Grams per square meter | | | | |
| | 15 | | | | |
| | Stretch ratio | | | | |
| | 4 | | | | |
| | Layer | Layer | Layer | Layer | Layer |
| | 1 | 2 | 3 | 4 | 5 |
| CaCO₃ | 49 wt % | — | 49 wt % | — | 49 wt % |
| Breathable | 21 wt % | — | 21 wt % | — | 21 wt % |
| layer | | | | | |
| material-1 | | | | | |
| Breathable | 30 wt % | — | 30 wt % | — | 30 wt % |
| layer | | | | | |
| material-2 | | | | | |
| Breathable | — | 100 wt % | — | 100 wt % | — |
| layer | | | | | |
| material-1 | | | | | |
| Percentage | 10 | 7 | 66 | 7 | 10 |
| of Total | | | | | |
| Thickness | | | | | |
| (%) | | | | | |

A number of properties were determined for Examples 1-6 and Comparative Examples A-C. The results are reported in Tables 10-11.

TABLE 10

| | | CD Tensile | MD Tensile | | Hydrostatic |
|---|---|---|---|---|---|
| | WVTR | Force at | Force at 5% | Puncture | Head |
| | (g/m² | break | elongation | Force | Pressure |
| | day) | (N) | (N) | (N) | (mbar) |
| Ex 1 | 778 | 1.3 | 3.0 | 1.4 | 109 |
| Ex 2 | 570 | 1.3 | 2.9 | 1.5 | 98 |
| Ex 3 | 720 | 1.4 | 2.7 | 1.4 | 91 |
| Ex 4 | 1055 | 1.5 | 2.8 | 1.4 | 100 |
| Ex 5 | 1073 | 1.3 | 3.3 | 1.5 | 110 |
| Ex 6 | 480 | 1.7 | 2.2 | 1.4 | 92 |
| Comp | 1628 | 1.1 | 3.5 | 1.4 | 113 |
| Ex A | | | | | |
| Comp | 512 | 1.2 | 3.0 | 1.5 | 108 |
| Ex B | | | | | |
| Comp | 0 | 1.6 | 4.4 | 1.8 | 115 |
| Ex C | | | | | |

The data of Table 10 show that each of Examples 1-6 had a WVTR greater than or equal to 400 g/m² day. A WVTR greater than or equal to 400 g/m² day indicates a breathable article.

The data of Table 10 show that Comparative Example C had a WVTR less than 400 g/m² day, and is a non-breathable article. As shown in Table 9, Comparative Example C included a layer (See layers 2 and 4) having a breathable layer material, i.e., Breathable layer material-1, while lacking CaCO₃.

The data of Table 10 show that each of Examples 1-6 had a maintained, or an improved i.e., greater, CD Tensile Force at break, as compared to breathable article Comparative Example A, which had a similar porous layer composition.

TABLE 11

| | MD Tear (g) |
|---|---|
| Example 5 | 42.0 |
| Comparative Example A | 1.5 |
| Comparative Example B | 19.2 |

The data of Table 11 show that Example 5 had an improved i.e., greater, MD Tear, as compared to both Comparative Examples A-B.

Example 1, a breathable article, was made as follows. Calcium carbonate (70 wt %) and Breathable layer material-1 (30 wt %) were thoroughly mixed to provide a Calcium carbonate mixture. The Calcium carbonate mixture and Breathable layer material-2 were fed to a 5 layer Collin Cast Line to make Porous Layers, and Non-porous layer material-5 was fed to the Collin Cast Line to make Non-porous layers. The 5 layer Collin Cast Line included four different extruders, one extruder had with a division in two channels that could provide two symmetric layers in a structure. Conditions for the Colin Cast Line are reported in Table 12.

Examples 2-6 and Comparative Example C were made as Example 1, with the layer ratio adjustment for Examples 5-6, with changes shown in Tables 2-6 and Table 9.

Comparative Examples A-B were made as Example 1, with Conditions for the Colin Cast Line reported in Table 13 and changes shown in Tables 7-8.

Output, i.e. respective films, from the Collin Cast Line was stretched by utilizing a series of heated rolls that are operational at various rotational speeds to orientate the film. The film was oriented in the machine direction. Initial rolls heated the film to the desired stretching temperature. Then, the film was passed through two closely pressed rolls moving at different speeds, where the speed difference was used to control the amount of stretching and/or orientation. Then, heated annealing rolls were utilized to secure the orientation and the film was cooled to room temperature by a set of cooling rolls to provide Example 1. Conditions for stretching/orientation utilized for Examples 1-6 and Comparative Examples A-C are reported in Table 14. Each sample had a stretch ratio of 4 and a basis weight of 15 grams/m².

TABLE 12
Structure: ABCBD

| Condition | Unit | Value |
|---|---|---|
| Set | % | A: 10, B: 14, C: 66, D: 10 |
| Melt Temperature | ° C. | 215 |
| Extruder A | | |
| Melt Temperature | ° C. | 210 |
| Extruder B | | |
| Melt Temperature | ° C. | 230 |
| Extruder C | | |
| Melt Temperature | ° C. | 215 |
| Extruder D | | |
| Feed Block 1 | ° C. | 230 |
| Feed Block 2 | ° C. | 230 |
| Total Output | kg/h | 4.5 |
| Final Thickness | μm | 47 |
| Screw Speed - Ext A | rpm | 6 |
| Screw Speed - Ext B | rpm | 6 |
| Screw Speed - Ext C | rpm | 23 |
| Screw Speed - Ext D | rpm | 15 |
| Chill Roll Speed | rpm | 5.6 |
| Air Flow | m³/s | 9.4 |

TABLE 13
Structure: ABCBD

| Condition | Unit | Value |
|---|---|---|
| Set | % | A: 30, B: 0, C: 40, D: 30 |
| Melt Temperature | ° C. | 220 |
| Extruder A | | |
| Melt Temperature | ° C. | — |
| Extruder B | | |
| Melt Temperature | ° C. | 220 |
| Extruder C | | |
| Melt Temperature | ° C. | 220 |
| Extruder D | | |
| Feed Block 1 | ° C. | 220 |
| Feed Block 2 | ° C. | 220 |
| Total Output | kg/h | 4.5 |
| Final Thickness | μm | 47 |
| Screw Speed - Ext A | rpm | 20 |
| Screw Speed - Ext B | rpm | 0 |
| Screw Speed - Ext C | rpm | 17 |
| Screw Speed - Ext D | rpm | 34 |
| Chill Roll Speed | rpm | 5.9 |
| Air Flow | m³/s | 9.4 |

TABLE 14

| Condition | Unit | Value |
|---|---|---|
| Preheating 1 & 2 | ° C. | 70 |
| Temperature | | |
| Preheating 3 & Stretching | ° C. | 85 |
| 1 Temperature | | |
| Preheating 5 & 6 | ° C. | 75 |
| Temperature | | |
| Preheating 7 & Stretching | ° C. | 75 |
| 1 Temperature | | |
| Annealing 1 & 2 | ° C. | 55 |
| Temperature | | |
| Cooling 1 & 2 Temperature | ° C. | Off |
| Line Speed of Preheating | rpm | 5.6 |
| 1, 2 & 3 | | |
| Line Speed of Stretch | rpm | 22.4 |
| Point 1 | | |
| Line Speed of Preheating | rpm | 22.4 |
| 4, 5 & 6 | | |
| Line Speed of Stretch | rpm | 22.4 |
| Point 2 | | |
| Annealing 1, 2 & Cooling | rpm | 22.4 |
| Unwinding roll Speed | rpm | OFF |
| Take of roll | rpm | 22.6 |
| Winding roll tension | kg | 3.5 |
| Electronic Ruler 1 | mm | 5.1 |
| Electronic Ruller 2 | mm | 22.1 |

Water Vapor Transmission Rate (WVTR) was determined in accordance with ASTM E398-03 on a Lyssy L80-5000 Water Vapor Permeability tester, with a temperature of 37.8° C. and 90% relative humidity, on 2.5 cm² sample area.

Basis weight was determined as the weight per unit of area of the samples. It is measured by weighting a square sample of 10 cm×10 cm.

Tensile tests: Cross Direction (CD) Tensile Force at break (N) and Machine Direction (MD) Tensile Force at 5% elongation (N) were determined on tensile testing machine, following ISO 527 on a 15 mm width samples. measured at 500 mm/min with grip distance of 100 mm.

Puncture Force was determined measured on a tensile testing machine, on a 40 mm diameter sample, using a probe tip of 1.2 mm at 250 mm/min.

Hydrostatic Head Pressure was determined according to ISO 811 and utilized Textest FX 3000 equipment on a 100 cm² area sample.

Machine Direction (MD) Tear Resistance was determined according to ASTM D1922-09.

Density was determined according to ASTM D 792, A1 Procedure C, Test within 1 hr, measured on compression molded plate prepared following ATSM D4703.

Melt index (I₂) was determined according to ASTM D1238, measured at 190° C. and with a 2.16 kg weight.

What is claimed is:

1. A breathable article comprising:
a porous layer comprising calcium carbonate and a breathable layer material, wherein the breathable layer material has a density greater than 0.915 g/cm³ and melt index (I₂) from 0.5 to 5 dg/min; and
a non-porous layer comprising a non-porous layer material, wherein the non-porous layer material has a density less than 0.910 g/cm³ and melt index (I₂) from 0.5 to 5 dg/min

2. The breathable article of claim 1, wherein the breathable layer material density is from 0.916 g/cm³ to 0.940 g/cm³ and the non-porous layer material density is from 0.850 g/cm³ to 0.909 g/cm³.

3. The breathable article of claim 1, wherein the breathable article comprises a plurality of porous layers.

4. The breathable article of claim 3, wherein calcium carbonate is from 40 to 60 wt % in each of the plurality of porous layers.

5. The breathable article of any one of claims 1-4, wherein the breathable article has a Water Vapor Transmission Rate greater than or equal to 400 g/m² day.

6. The breathable article of any one of claims 1-5, wherein the breathable layer material comprises linear low-density polyethylene.

7. The breathable article of any one of claims 1-6, wherein the non-porous layer material comprises an ethylene-based polymer.

8. The breathable article of any one of claims 1-6, wherein the non-porous layer material comprises a propylene-based polymer.

9. The breathable article of any one of claims 1-8, wherein the breathable article includes 3 to 11 layers, and the 3 to 11 layers is a sum of a number of porous layers and a number of non-porous layers.

10. The breathable article of claim 9, wherein each of the number of porous layers has a first same composition and each of the number of non-porous layers has a second same composition, where the first same composition is different than the second same composition.
